(19) United States
(12) Patent Application Publication
(10) Pub. No.: US 2018/0047124 A1
(43) Pub. Date: Feb. 15, 2018

(54) SYSTEM AND METHOD FOR OPTIMIZING A RAIL SYSTEM

(71) Applicant: HATCH LTD., Mississauga (CA)

(72) Inventors: Danielle Zyngier, Burlington (CA); Ludwig Furstenberg, Langebaan (ZA)

(21) Appl. No.: 15/658,840

(22) Filed: Jul. 25, 2017

Related U.S. Application Data
(60) Provisional application No. 62/374,493, filed on Aug. 12, 2016.

(51) Int. Cl. G06Q 50/28; G06Q 10/06

(52) U.S. Cl. CPC G06Q 50/28; G06Q 10/06314; G06Q 10/067

(57) ABSTRACT

A method and system for optimizing a train rail system. The method comprises creating a model of the rail system in a memory, creating an objective function in the memory, and determining, using a computer, a configuration of the rail system which optimizes the objective function for the process systems model. The model may be a process systems model. The aspect being optimized may be a train schedule for the rail system. The trains may be operated in accordance with the train schedule. The system comprises a computer and a memory. The memory stores a program configured to create in the memory the model, create the objective function, and determine the configuration of the rail system, using the computer, which optimizes the objective function for the model.

### CROSS-REFERENCE TO RELATED APPLICATION

This application claims priority to U.S. Provisional Patent Application 62/374,493 titled SYSTEM AND METHOD FOR OPTOMIZING A RAIL SYSTEM filed on Aug. 12, 2016 which is incorporated herein by reference in its entirety.

### FIELD

The present disclosure relates to the field of rail systems for trains (also referred to as rail systems or rail networks). More particularly, the present disclosure relates to the field of software and systems for optimizing rail systems.

### BACKGROUND

Trains are scheduled in a rail system to avoid conflicts. A conflict is when two trains are to use the same section of a single-track rail at the same time. Scheduling trains comprises determining the window of time when each train should depart a particular location (typically a train station) in a rail system over a particular time horizon. A train schedule must have no conflicts to be used to operate trains in a rail system.

In many cases, it is desirable for a train schedule to maximize the utilization of the capacity of the rail system as much as possible. Rail system utilization may be characterized as the average percentage of time the rail system is occupied by trains. For example, an operator may strive for 65% or greater rail system utilization. Rail scheduling is a challenging problem due to spatial and temporal characteristics which need to be accounted for in the schedule. Rail lines can be hundreds of kilometers long, while passing train strategies are determined at a station level requiring the analysis of the problem on a time scale of seconds and minutes. A train schedule which could result in high utilization of the rail system may leave little room to accommodate unscheduled events resulting in conflicts. When conflicts are encountered, it is helpful to have a flexible rail network to resolve such conflicts on a station-to-station basis.

Train scheduling can be performed manually by human operators. Once a conflict-free pattern for launching trains has been determined for a particular rail system, the pattern tends to be repeated. Trains may also be scheduled using conventional discrete event simulation and/or rule-based scheduling software technology (also referred to as tools). Conventional train scheduling software is unable to reliably create train schedules with no conflicts. This is especially true for rail systems with limited flexibility.

Flexible rail networks comprise many double track rail segments which permit trains to cross each other simultaneously, as well as significant yard capacity at intermediate stations (where trains can wait). If an actual conflict develops, the large number of double track rail segments and yard capacity permits the conflict to be resolved using the capacity of adjacent stations (i.e. on a station-to-station basis) rather than needing to identify and resolve the conflict in advance of the trains entering the two adjacent stations, respectively. This is because there is sufficient infrastructure flexibility in both stations to accommodate both trains at the same time.

Not all rail systems have scheduling flexibility. For example, a rail system may have long single-line rail segments interspersed with a limited number of double-line rail segments. Scheduling flexibility may be further limited if the rail system is a mixed-use rail system such as freight trains and passenger trains. Mixed-use rail systems typically have one or more different lengths trains, trains with different travelling times, and trains with different priorities. A mixed-use rail system may also have an assortment of passing loops lengths. If only a few of the passing loops can accommodate longer trains, this can add further complexity to, and reduce scheduling flexibility in, the rail system.

Even if a rail system typically has scheduling flexibility, events occurring in the rail system can reduce that system's flexibility. The events may be unforeseen such as locomotive failures or train derailments. The events may also be planned such as track maintenance. Re-establishing a train schedule with no conflicts after an unexpected event can be challenging, especially for conventional software if the rail system has become inflexible because of the event. An original train schedule may sacrifice rail system utilization to help with recovering from unexpected events.

The convention software generates train schedules through sequential decision-making strategies. The software is simulation-based and/or relies on rules and heuristics to avoid and resolve conflicts. When the software detects a conflict, it back-tracks the potential schedule by a certain amount and attempts alternative options until the conflict is resolved. There are too many interrelated elements in a rail system for the current technology to simulate and identify a schedule with no conflicts in all cases where a no-conflict train schedule actually exists. Indeed, the number of alternatives to check for even a 2-day time horizon train schedule may be so significant in a rail system with limited flexibility that the software cannot identify a feasible schedule (i.e. a schedule which has no conflicts). The conventional software is typically ill-suited for actually developing a conflict-free train schedule in systems with limited flexibility, slow at determining train schedules, and unable to account for all of the intricacies of rail systems, especially rail systems with limited scheduling flexibility. Furthermore, such conventional software is typically limited to determining a train schedule for the purpose of trying to maximize train usage of existing rail system infrastructure.

An improved system, method, and software is desired to help optimize a rail system, including creating train schedules with no conflicts in limited flexibility rail systems.

### BRIEF DESCRIPTION OF THE FIGURES

FIG. 1 shows a graphical representation of a portion of a rail system.

FIG. 2 shows, in accordance with an embodiment of the present disclosure, a graphical representation of a model of the portion of the rail system of FIG. 1 with two sections and one passing loop.

FIG. 3 shows, in accordance with another embodiment of the present disclosure, a graphical representation of a model of another portion of a rail system having three sections and two passing loops.

FIG. 4 shows representations, in accordance with an embodiment of the present disclosure, of single-line and double-line rail sections.

FIG. 5 shows a representation of two trains moving in the same directions, and a representation of two trains approaching each other from the opposite directions.

FIG. 6 shows, in accordance with another embodiment of the present disclosure, a graphical representation of a model of a third portion of an example rail system.

FIG. 7 shows a flow chart of a method for modeling a rail system in accordance with an embodiment of the present disclosure.

FIG. 8 shows a flow chart of a method for optimizing a rail system in accordance with an embodiment of the present disclosure.

FIG. 9 shows a Gantt chart for a 1-week train schedule created in accordance with an embodiment of the present disclosure.

### DETAILED DESCRIPTION

The present disclosure describes a method and system for helping optimize aspects of a rail system using computer-based mixed integer linear programming or integer programming optimization methodology. The method and system provide a time-based decision support system. In an embodiment, a rail system is modeled in a memory of a computer as a process systems model, an objective function is created in the memory, and a configuration of the rail system is determined by optimizing, using a computer, the objective function according to constraints in the process systems model.

Process systems are typically used in industrial production facilities to converts raw materials (such as chemicals), into value-added components. Rail sections may be represented in a process systems model as batch process units and passing loops may be represented in the process systems model as pool units. Train types may be represented in the process systems model as operation modes associated with the batch process units and/or pool units. The process systems model represents constraints associated with the rail system. The constraints can be expressed as equations comprising variables. The process systems model representation of the rail system may be based on the Unit-Operation-Port-State Superstructure (UOPSS) methodology.

The objective function expresses mathematical and logical relationships of real-world factors relevant for assessing whether a particular goal has been achieved. The objective function comprises decision variables which correspond to one or more of the variables in the constraints of the process systems model. The aspect of the rail system for optimization may be the scheduling of trains in the rail system, the optimization comprising finding the train schedule which maximizes the train flows into and out of the rail system. The aspect to be optimized may be track configuration, the optimization comprising finding the lowest cost track configuration, from amongst a plurality of potential track configurations, which results in a selected threshold improvement in the capacity of the rail system.

In an embodiment, a configuration of the rail system is determined by optimizing, using a computer, the objective function according to the constraints in the process systems model. The computer may use an optimization solver program to optimize the objective function.

In accordance with an embodiment of the present disclosure, a method for determining a train schedule for a rail system using a computer, comprises: creating in a memory of the computer a process systems model representing the rail system, the process systems model comprising variables; creating in the memory an objective function comprising decision variables corresponding to one or more of the variables in the process systems model; and determining, using the computer, the train schedule by identifying the values of the decision variables which optimize the objective function for the process systems model.

The process systems model may be a Unit-Operation-Port State Superstructure model.

Creating the process systems model may comprise: representing a section of the rail system as a batch process unit; and representing train characteristics of trains, which may traverse the section, as operation modes associated with the batch process unit.

Creating the process systems model may comprise: representing a passing loop of the rail system as a pool unit; and representing train characteristics of trains, which may traverse the passing loop, as operation modes associated with the pool unit.

The method may comprise operating trains in the rail system according to the train schedule.

In accordance with another embodiment of the present disclosure, a method for determining, using a computer, a configuration which optimizes an aspect of the rail system, comprises: creating in a memory of the computer a process systems model representing the rail system, the process systems model comprising variables; creating in the memory an objective function corresponding to the aspect of the rail system for optimization, the objective function comprising decision variables corresponding to one or more of the variables in the process systems model; and determining the configuration based on identifying, using the computer, values of the decision variables which optimize the objective function for the process systems model.

The process systems model may be based on the Unit-Operation-Port State Superstructure methodology.

Creating the process systems model may comprise: representing a section of the rail system as a batch process unit; and representing train characteristics of trains, which may traverse the section, as operation modes associated with the batch process unit.

Creating the model may comprise: representing a passing loop of the rail system as a pool unit; and representing train characteristics of trains, which may traverse the passing loop, as operation modes associated with the pool unit.

Creating the model may comprise representing track characteristics in the operation modes.

The train characteristics may comprise one or more of train size, train speed, train direction, and train priority.

Track characteristics may comprise one or more of section availability, and the number of parallel rails.

Creating the process systems model may comprise representing a connection between two sections as a relationship between the operation modes of the batch process unit for each of the two sections.

Creating the process systems model may further comprise representing a connection between the section and the passing loop as a relationship between the operation modes of the batch process unit and the pool unit.

The aspect of the rail system for optimization may be a train schedule for the rail system.

The method may comprise populating the process systems model to reflect locations of trains within the rail system prior to determining the train schedule.

The variables may be defined in the memory as a combination of continuous and integer variables.

The variables may be defined in the memory as integer variables.

The method may comprise adjusting the process systems model in response to an event in the rail system, and determining a revised train schedule based on the adjusted model.

The method may comprise adjusting the process systems model based on batch or continuous updates concerning a state of the rail system and rapidly providing a short-term optimization of the train schedule.

The method may comprise receiving information about the event within less than five minutes after the time at which the event occurred.

The event may be a disruption to operation of the rail system according to the train schedule, and the revised train schedule may be optimized to reestablish operation of the rail system according to the train schedule.

Creating the process systems model may comprise adding a block section variable to the model in response to the rail system having a series of sections between passing loops of different lengths, the block section variable to permit or prevent use of all of the batch process units associated with the series of sections.

The aspect for optimization may be the track configuration of a portion of the rail system, the configuration selected from a plurality of potential track configurations.

The plurality of potential track configurations may comprise a plurality of potential passing loops.

The method may comprise operating trains in the rail system according to the train schedule.

In accordance with another embodiment of the present disclosure, a method for modeling a rail system in a computer memory, comprises: representing a section of the rail system as a batch process unit: representing a passing loop of the rail system as a pool unit; and representing train types of trains which may traverse the section or the passing loop as operation modes associated with the batch process unit or pool unit.

In accordance with another embodiment of the present disclosure, a method for determining a modification to a rail system from a plurality of possible modifications using a computer, comprises: creating in a memory of the computer a process systems model representing the rail system and the plurality of possible modifications to the rail system, the process systems model comprising variables; creating in the memory an objective function comprising decision variables corresponding to one or more of the variables in the process systems model; and determining, using the computer, the modification from the plurality of potential modification by identifying the values of the decision variables which optimize the objective function for the process systems model.

In accordance with another embodiment of the present disclosure, a system for determining, using a computer, a configuration which optimizes an aspect of the rail system, comprises: a computer; and a memory storing a program configured to, using the computer, create in a memory of the computer a process systems model representing the rail system, the process systems model comprising variables; create in the memory an objective function corresponding to the aspect of the rail system for optimization, the objective function comprising decision variables corresponding to one or more of the variables in the process systems model; and determine the configuration based on identifying, using the computer, values of the decision variables which optimize the objective function for the process systems model.

The memory may store an optimization solver program.

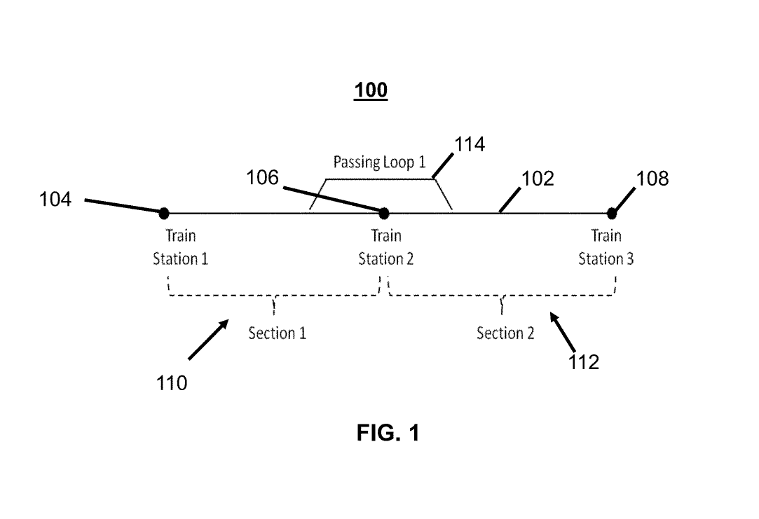

FIG. 1 shows a graphical representation of a portion of a rail system 100. The rail system 100 comprises a single-line rail 102, and three train stations 104, 106, 108 along that rail line 102. Between the train stations 104, 106, 108 are a first section 110 and a second section 112 of the line 102. The rail system 100 also comprises a passing loop 114. A passing loop runs parallel to the rail line permitting two trains to pass each other.

Sections of a rail line are delineated by the passing loops which branch off of the rail line. Each passing loop denotes a station, and each station denotes the intersection of two adjacent sections. The station (and the intersection of two sections) is typically considered to be the point on the main rail line that is parallel to the midpoint of the passing loop. The station (and intersecting point of two sections) may, however, be anywhere along the main rail line between the ends of the passing loop. As shown in FIG. 1, the midpoint of passing loop 114 divides the first section 110 from the second section 112.

In the rail system 100, a train enters the first section 110, stays within that section 110 for a certain amount of time (e.g. the amount of time it takes for the train to travel the length of the section), and then exits the section 110 into the next section 112. Once the train has left the section 110, another train can enter the section 110. Two trains are not permitted to be in the same section of a single-line rail at the same time.

In single-line rails, trains can only cross (also referred to as pass) each other if there is a passing loop 114 that is sufficiently long to hold the full length of the shortest train. One or more trains can enter a passing loop up to the capacity of the passing loop. The trains remain in the passing loop for a period of time to permit other train(s) to transit the section(s) 110, 112 of the main rail line 102.

Process systems typically comprise operations that are performed in an industrial production setting to convert raw materials into value-added components or materials. Typical process systems receive or produce chemicals, gases, agricultural products, minerals, food, pharmaceuticals, advanced materials, or any combination of the foregoing. Certain aspects of a process system may be configured or tailored to achieve a particular result with that system. Process systems can be modeled in a computer. The model can be used to help determine, using the computer, the optimal configuration of the process system to achieve a particular goal. For example, the goal may be to maximize the output of the system or the revenue from such outputs, minimize the inputs into the system or the cost of such inputs, or maximize the income resulting from the use of the system.

A model of a process system may be represented as a series of equations reflecting real-world constraints in the system. A goal may be expressed as an objective function. The objective function comprises decisions variables. At least some of those decision variables correspond to variables in constrains of the model of the system. For complex process systems, a computer may be used to determine the values of the decision variables which optimize the objective function while adhering to the constraints characterized by the model.

There are various methodologies to assist with modeling process systems such as State-Task Network, Resource-Task Network, and Unit-Operation-Port-State Superstructure (UOPSS). The methodologies assist with determining the equations to use to represent a process system.

In the UOPSS methodology, decision-making process system blocks are classified according to their fill-hold-draw (FHD) logistic characteristics. In a fill-hold-draw block, there are three types of operations: filling a vessel with materials, holding the materials in the vessel, and expelling the materials from the vessel. Two FHD characteristic classifications are batch process units and pool units. In a batch process unit, raw material is loaded (all at once or in several stages). After a certain processing time elapses, product is removed. In a pool unit, indefinite amounts of materials can be added and/or removed at unspecified times, including at the same time.

The system and method of the present disclosure describe a computer-enabled process which employs a collection of formulas expressing mathematical and logical relationships to represent or model limitations of a real-world rail system in a computer. The model and associated formulas are based on the operation of process systems, but are adapted to the unique constrains of a rail system. The present disclosure describes using the significant processing power of a computer to help determine an optimal configuration of an aspect of a rail system to satisfy a particular goal, constrained according to the model.

The method and system of the present disclosure provide a number of benefits over conventional train scheduling software. Modeling a rail system with a computer in accordance with process systems methodology is a marked departure from conventional train scheduling software which in some cases attempts to fully simulate the rail system in the computer. Despite their significant processing power, it is still not possible for current computers to simulate all possible rail system scenarios to achieve feasible train schedules based on conventional simulation algorithms. The system and method of the present disclosure is an improvement over conventional train scheduling software. The present disclosure provides a process which helps reduce the amount of processing a computer is required to perform to determine a sufficiently optimal rail system configuration, such as a train schedule. In other words, the present disclosure provides a more efficient computer process. In addition to determining a train schedule, the process of the present disclosure can be used to optimize other aspects of a rail system other than a train schedule.

In accordance with an embodiment of the present disclosure, a rail system is modeled according to a process systems model in the memory of a computer. An intermediate model of the rail system may be created in a memory of a computer as objects via an object-oriented computer language such as C++, Java, and Python. Creating such an intermediary model can help with both representing the model on a graphical user interface to facilitate human interaction, and automatically converting, using a computer, to a final model having mathematical and logical relationships which can be used in optimization operations.

To facilitate the creation of the intermediary model in the memory, general classes of the model objects (such as batch process units and pool units) may be predefined. The classes may have attributes and relationships in accordance with a particular process system model methodology. Objects may then be created in the memory based on the classes to represent the actual elements of a particular rail system.

The intermediate model is converted, using the computer, into a final process system model of the rail system in the memory. The final process system model consists of a series of equations expressing mathematical and logical relationships. The equations define real-world constraints and degrees of freedom in the rail system.

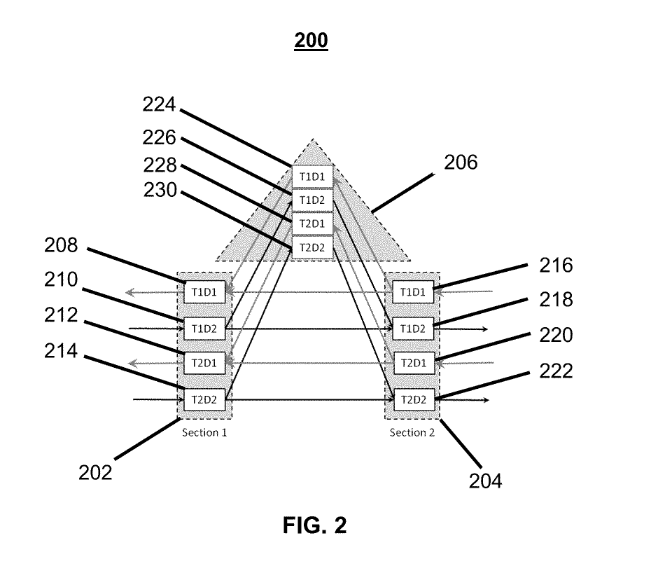

FIG. 2 shows a graphical representation of a model 200 of the rail system 100 of FIG. 1 in accordance with an embodiment of the present disclosure. The model 200 is in accordance with a process system model. Rail line sections 110, 112 are represented as batch process units 202, 204. Passing loop 114 is similarly represented as a pool unit 206. A pool unit is used to represent the one or more trains that can be in a corresponding passing loop at any point in time. A particular type of train (based on its unique combination of train characteristics) passing through a rail line section or a passing loop may be represented as a state (also referred to as an operation mode) in the corresponding batch process unit or pool unit. A station yard which has capacity to accommodate one or more trains is, effectively, a passing loop. Accordingly, station yards may be represented as pool units in the model.

In accordance with an embodiment of the present disclosure, batch process units and pool units may each have one or more operation modes associated therewith. Each operation mode represents a type of train which may traverse a particular section or passing loop. There is a train type for each unique combination of real-world train characteristics and/or track characteristics. Train characteristics can include, for example, train use type (e.g. passenger or freight), train length (which may be associated with one or more train use types), train weight (by axle or otherwise), train speed, train load, train braking system capacity, train direction, and train priority. These train characteristics may be more generally represented according to train size, speed, direction, and priority. For example, one train type may be a train with a long length that travels at a slow rate in a first direction and has a low priority. A second train type may be a train with a short length that travels at a fast rate in the first direction and has a low priority. Track characteristics can include, for example, availability and the number of parallel rails for a particular section of track.

The number of operation modes may depend on the number of desired train characteristics to be considered. As shown in FIG. 2, a particular train passing through a rail line section 110 or passing loop 114 may be represented as one of the operation modes 208, 210, 212, 214 in the batch process unit 202, and operation modes 224, 226, 228, 230 in the pool unit 206. If the passing loop can hold more than one train at a time, an inventory constraint of the pool unit is set to the number of trains which can be accommodated by the pool unit at any one time. The single-use constraint of the pool unit (which requires only one operation mode to be active at any one time) is also removed.

A section or passing loop may have restrictions. The restrictions may be based on train characteristics and/or track characteristics. For example, a single-track section can only permit a train to proceed in one direction but not the opposite direction at the same time. A section or passing loop may also only be able to accommodate trains of a particular length but not all lengths.

The method and system of the present disclosure may generate a discrete time schedule. At certain times during that schedule, however, a portion of the rail system may not be available due to, for example, track maintenance. Accordingly, to account for a section of track that is not available during a period of time in the model, the section's availability (represented by setup variable y_{s,m,d,t} in the model as further discussed below) may be set to a value of zero for the period of time. It may be necessary to account for unavailable tracks in the model when the actual track is, for example, undergoing maintenance. The method and system will find a feasible train schedule that satisfies this requirement if one exists.

In an embodiment, the collection of operation modes associated with a particular batch process unit or pool unit represents the different trains (based on the number of unique combinations of train characteristics) which may be able to traverse the corresponding section/passing loop.

The model 200 in FIG. 2. shows as many operation modes for each train section and passing loop as there are train types in each direction. More specifically, a batch process unit 202 comprises four operation modes 208, 210, 212, 214. The operation modes 208 and 210 represent a first train type (T1) travelling in a left direction (D1) and a right direction (D2), respectively. The operation modes 212 and 214 represent a second train type (T2) travelling in a left direction (D1) and a right direction (D2).

In the model 200, each operation mode in batch process unit 202 has a connection to a corresponding operation mode in the other batch process unit 204 and the pool unit 206. Notwithstanding, in accordance with the present disclosure, there may be different connectivity between rail sections and passing loops depending upon the characteristics of the trains those sections and passing loops can accommodate. For example, a short passing loop may be unable to accommodate a freight train because of the freight train's length. Such limitations may be represented in a model by limiting connectivity between the operation modes of each section and/or passing loop.

In an embodiment, the following formulas may be used to represent mathematical and logical relationships of elements of the rail system in a process systems model. These formulas are based on the UOPPS methodology. In accordance with an embodiment of the present disclosure, the nomenclature used in the formulas is as follows:

Sets: section (s), direction (d), large section (Is), mode/train type (m), passing loop (pl), and time (t).

Parameters: UT_{s,m,d} is the uptime of mode m in section s in direction d.

Variables:

y_{s,m,d,t} is the setup of section s running train m in direction d in time period t.
su_{s,m,d,t} is the startup of section s running train m in direction d in time period t.
sd_{s,m,d,t} is the shutdown of section s running train m in direction d in time period t.
FPLi_{pl,m,d,t} is the flow of train m into passing loop pl in direction d in time period t.
FPLo_{pl,m,d,t} is the flow of train m out of passing loop pl m in direction d in time period t.
InvPL_{pl,m,d,t} is the number (also referred to as inventory) of trains m in passing loop pl in direction d in time period t.
yL_{ls,m,d,t} the setup of large section ls running train m in direction d in time period t.
Throughput_{m,d,s} is the total number of trains of train type m that goes through section s in direction d.

A section of a rail system may be represented as a batch process unit in a process systems model of the rail system using the following two formulas:

Σₜₜ₌₀^{UT}^{_{s,m,d}}⁻¹su_{s,m,d,(t-tt)}=y_{s,m,d,t}∀s,m,d,t|(t−tt)≧0 Equation 1

sd_{s,m,d,t}=su_{s,m,d,(t-UT}_{_{s,m,d}}₊₁₎∀s,m,d,t|(t−UT_{s,m,d}+1)≧0 Equation 2

A passing loop of a rail system may be represented as a pool unit in a process systems mode of the rail system using the following formula:

InvPL_{pl,m,d,t}=InvPL_{pl,m,d,t-1}+FPLi_{pl,m,d,t}−FPLo_{pl,m,d,t}∀pl,m,d,t Equation 3

As discussed above, a sections or passing loop of a rail system may only be able to accommodate one type of train in one direction at a point in time. This is referred to as a single-use constraint.

A single use constraint for a passing loop may be represented in the process system model of the rail system using the following formula:

ΣₘΣ_{d}InvPL_{pl,m,d,t}≦1∀pl,t Equation 4

A single-use constraint for every section in every direction may be represented using the following formula:

Σₘy_{s,m,d,t}≦1∀s,d,t Equation 5

A single-use constraint for a single-line section may be represented in the process system model of the rail system using the following formula:

ΣₘΣ_{d}y_{s,m,d,t}≦1∀t,s=single line section Equation 6

The following formulas are used to represent the constraints of connections between adjacent sections and a passing loop:

sd_{us,m,d,t}≧FPLi_{pl,m,d,t}∀s,pl,m,d,t Equation 7

su_{ds,m,d,t}≧FPLo_{pl,m,d,t}∀s,pl,m,d,t Equation 8

su_{ds,m,d,t}≦sd_{us,m,d,t}−FPLi_{pl,m,d,t}+FPLo_{pl,m,d,t}∀s,pl,m,d,t Equation 9

su_{ds,m,d,t}+FPLi_{pl,m,d,t}≧sd_{us,m,d,t}∀s,pl,m,d,t Equation 10

sd_{us,m,d,t}+FPLo_{pl,m,d,t}≦1 Equation 11

where “us” and “ds” correspond to sections that are upstream and downstream, respectively, of passing loop pl.

Alternatively, if adjacent sections do not have a passing loop therebetween (e.g. when at least one of the adjacent sections is a multi-line rail), the following formula is used (instead of the formulas in Equations 7 to 11) to represent the constraints of connections between the adjacent sections:

su_{ds,m,d,t}−sd_{us,m,d,t}=0 Equation 12

A single-use constraint for a plurality of adjacent sections may be represented in the process system model of the rail system using the following formulas:

yL_{ls,m,d,t}≧y_{s,m,d,t}∀ls,s,∈ls,d,m,t Equation 13

Σ_{d}yL_{ls,m,d,t}≦1∀ls,m,t Equation 14

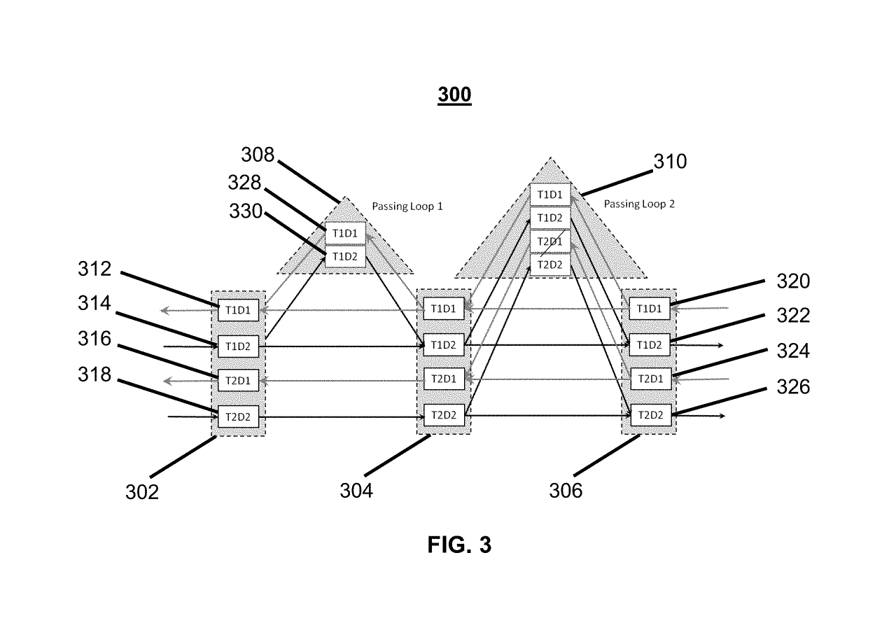

FIG. 3 shows a graphical representation of a model 300, in accordance with another embodiment of the present disclosure, of another portion of a rail system which is similar to the portion of the rail system 100 of FIG. 1. The second portion, however, comprises a short passing loop and a long passing loop (instead of one passing loop), and three sections (instead of two sections). The short passing loop and long passing loop are represented as a first pool unit 308 and a second pool unit 310, respectively. The three sections are represented by batch process units 302, 304, 306. The short passing loop can only accommodate trains of a first type (that are short). The long passing loop can accommodate both the trains of a first type (that are short) and trains of a second type (that are long). To represent the limitations of the short passing loop in the model 300, only two operation modes 328, 330 are associated with the first pool unit 308. In other words, the first pool unit 308 can never be in an operation mode other than the operation modes corresponding to the short train type. By contrast, the second pool unit 310 comprises all four operation modes, namely, two directions (D1, D2) for each of the two train types (T1, T2).

The connections between the operation modes also reflect the real-world limitations with respect to the short passing loop. Operation modes T1D1 and T1D2 in each of batch process units 302, 304 have connections to operation modes T1D1 and T1D2 in the first pool unit 308. Operation modes T2D1 and T2D2 in the batch process units 302, 304, however, have no corresponding connections to the first pool unit 308.

Train travel times (runtimes) through the rail system may not only be different between train types, but may also be different between the same train type operating in opposite directions. This may be due to the existence of hills across the rail system, train load, type of train braking system, and train configuration (e.g. number and type of locomotives, number and type of wagons/cars).

In an embodiment of the present disclosure, additional operation modes may be associated with a batch process unit or pool unit to model a same train type having different travel times depending on the travel direction. By explicitly modeling each train type with a particular direction, different runtimes can be assigned.

Single-track rails (also referred to as single-line rails) may coexist with double-track or multi-track rails (also referred to as double-line or multi-line rails). Single-track rails cannot accommodate two trains travelling in the same section at the same time. By contrast, multi-track rails permit trains to simultaneously travel in the same section at the same time, so long as there is no more than one train on each track of the section. Limited flexibility systems may contain both single-track rails and multi-track rails. In accordance with an embodiment of the present disclosure, a multi-track rail section may be represented in a process systems model as a single batch process unit comprising an additional variable representing the number of trains that can traverse the track at the same time.

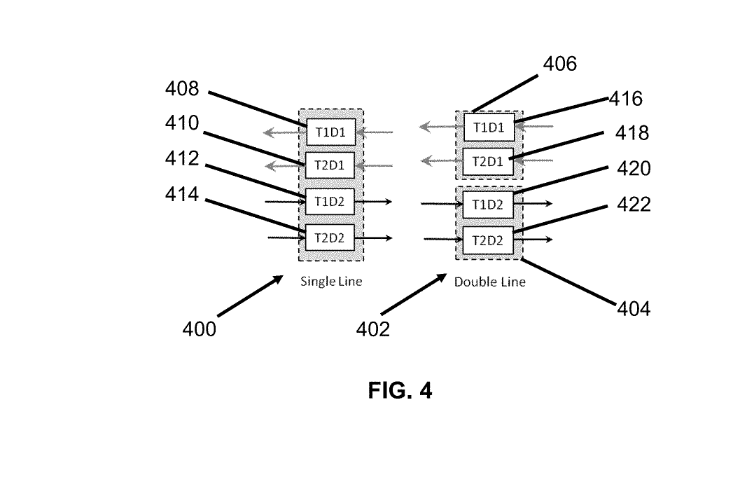

FIG. 4 shows a representation 400, 402 for each of a single-track section, and a double-track section, respectively. For the single-track section representation 400, all four operation modes 408, 410, 412, 414 (two train types for each of two directions) are represented in the single-use constraint. For the double-track section representation 402, however, there are two independent single-use constraints 404, 406: one for each direction. Based on the double-track section representation 402, it follows that only one train type can be traveling in a particular direction in the section in a time period, but that the same train type or different train types may be travelling in an opposite direction in the section for the same time period. A station (and the intersection of two adjacent sections) is located at the point a single-track rail turns into a multi-track rail. The full length of a multi-track rail may be one entire section. A multi-track rail may be subdivided into multiple smaller sections. The distance between each of the smaller sections permits sufficient headway between trains traveling in those sections so trains can follow one another. The connection between two adjacent sections of a subdivided multi-track rail may be modeled using Equation 12 su_{ds,m,d,t}−sd_{us,m,d,t}=0.

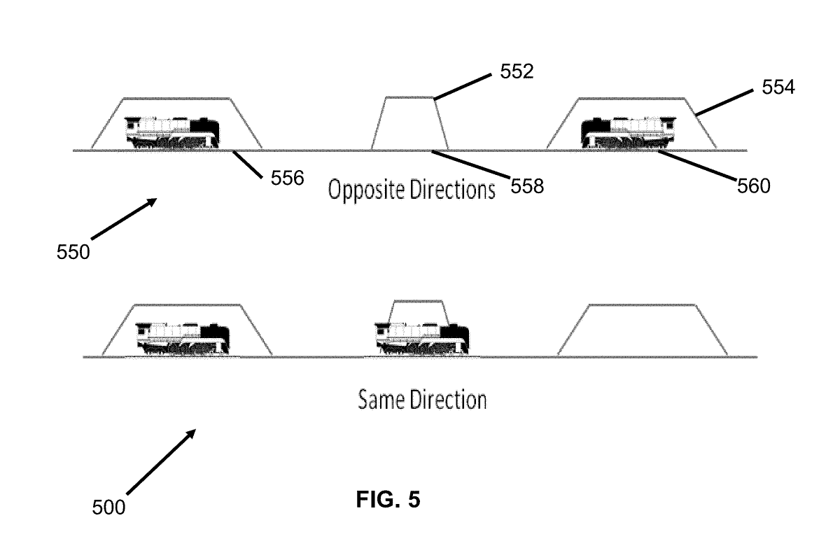

FIG. 5 shows a representation 500 of two trains moving in the same direction on the same rail, and a representation 550 of two trains approaching each other from the opposite directions on the same rail. Each representation 500, 550 shows sections and three passing loops, namely, two longer passing loops and a shorter passing loop. Trains (whether long or short) may follow each other from section to section when traveling in the same direction. When trains approach each other from opposite directions, however, one of the trains must pull into the passing loop and wait for the other oncoming train(s) to completely clear all sections up until the passing loop before emerging. Where the trains are long trains as shown in representation 550, and the sections between the trains connect to a short passing loop 552 (that is unable to accommodate either train) and a long passing loop 554 (able to accommodate a train), one of the trains must wait in the long passing loop 554 for the other train to clear all sections 556, 558, 560 between the two passing loops 552, 554. In other words, the presence of a long train in a section 556 precludes a series of adjacent sections 558, 560 from being occupied by another long train if it is approaching from an opposite direction. Such real-world constraint may need to be incorporated into a model in accordance with the present disclosure. Dividing a rail into sections according to the locations of longer passing loops, only, for the purpose of creating the model may result in overly conservative solutions. This is because the model would represent two or more single-track sections as one longer section. Even though a train could occupy each of the sections, since the model treats the multiple sections as only one longer section, the train schedule would not have multiple trains in the one longer section at the same time.

In an embodiment of the present disclosure, a variable may be associated with a series of batch process units between two or more passing loops, when only one of those passing loops can accommodate a long train. The variable may be referred to as a large section variable. When representing a long train passing through one of the series of batch process units, the large section variable is enabled (binary value of “1”) for all of the other batch process units. This places a constraint on the model that inhibits, during optimization, any of the sections from being used by another long train when a long train is already in one of those sections. In other words, it forces another approaching long train to wait in the long passing loop while the first long train clears the series of batch process units. A single use constraint on this new binary variable helps ensure the representation of only one of these sections being active when trains are traveling towards each other in opposing directions, but also helps ensure the representation of all of these sections being active when trains are following each other in the same direction, as shown in Equations 13 and 14.

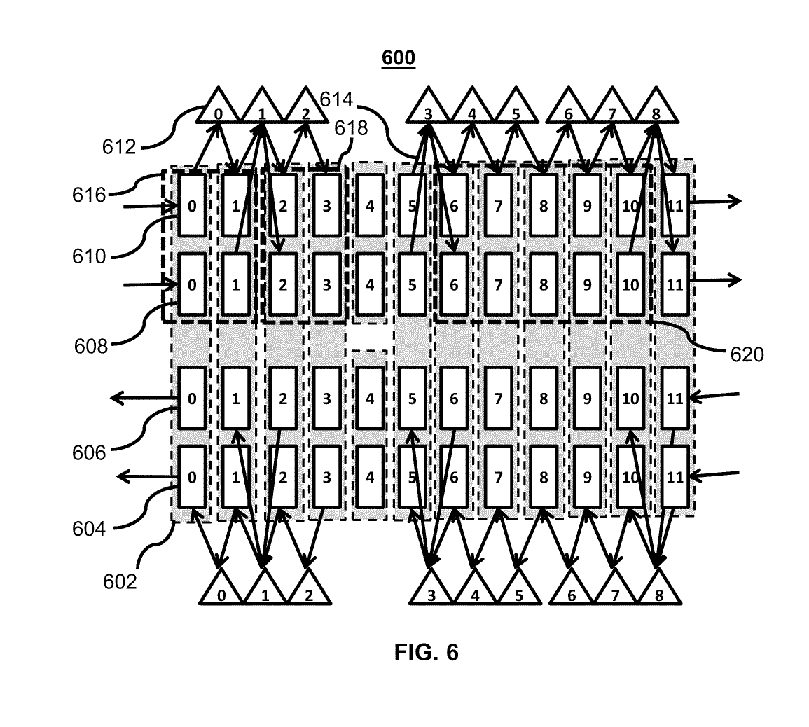

FIG. 6 shows a graphical representation of a model 600, in accordance with an embodiment of the present disclosure, of a third portion of a rail system. The third portion is larger and more complex than the portions of rail systems modeled in FIG. 2 and FIG. 3. As can be extrapolated from the graphical representation of the model 600, the portion of the third rail system comprises 12 sections (sections 0 to 11). Each section can accommodate two types of trains (e.g. a short train type and a long train type) in either direction. Section 0 to 3 is each a single-track rail. Section 4 is a double-track rail that is able to accommodate two trains at the same time. Section 5 to 11 is each a single-track rail. There are 9 passing loops (0 to 8). Passing loops 0 connects to sections 0 and 1 but can only accommodate one type of train (e.g. a short train type) in either direction. Passing loop 1 connects to sections 1 and 2 and can accommodate both types of trains in either direction. Passing loop 3 connects to sections 5 and 6 and can also accommodate both types of trains in either direction. Passing loops 4, 5, 6, and 7 connects to section pairs 6-7, 7-8, 8-9, and 9-10, respectively but can only accommodate one type of train (e.g. the short train) in either direction. Lastly, passing loop 8 connects to sections 10 and 11 and can accommodate both types of trains in either direction.

As show in the visual representation of the model 600, in accordance with an embodiment of this disclosure, each of the sections is represented as a batch process unit 602. Each batch process unit 602 comprises four operation modes 604, 606, 608, 610 representing each of the two types of trains for each direction. Each of the passing loops is represented as a pool unit 612. Connectors 614 help model which passing loops can accommodate which types of trains.

Since passing loop 1 can accommodate long train types, but passing loops 0 and 2 cannot, the operation modes representing right-travelling trains for sections 0-1 616, and sections 2-3 618 are each modeled with an additional variable (also referred to as an adjacency constraint). The additional variable yL in Equations 13 and 14 help ensure that when two long trains are approaching each other from opposite directions, both sections are unavailable if any one of the sections is occupied by one of the trains. Similarly, the operation modes representing right-traveling trains for sections 6, 7, 8, 9, and 10 620 are also modeled with the additional variable since only passing loops 3 and 8 can accommodate long trains.

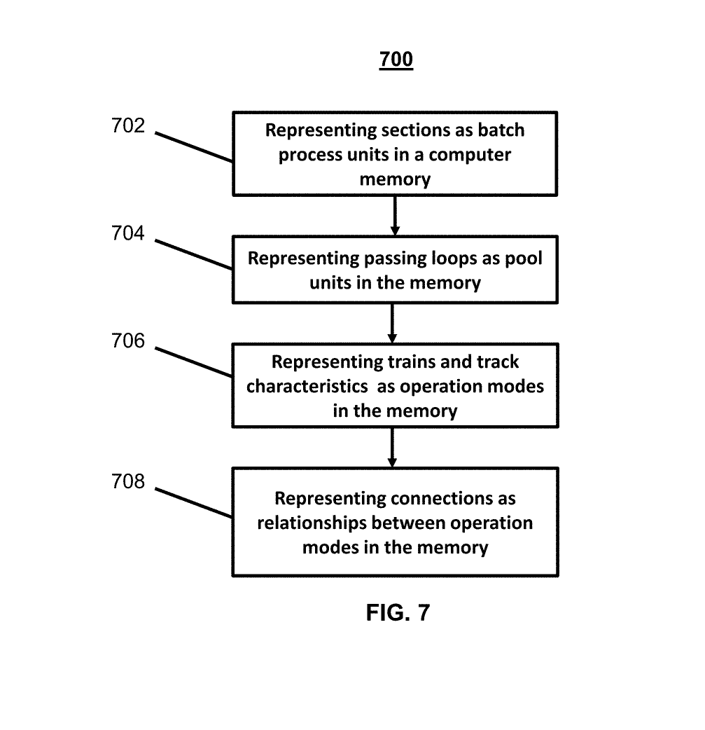

FIG. 7 shows a flow chart of a method 700 for modeling a rail system based on a process system model. The method 700 comprises representing, in a memory of a computer, sections as batch process unit 702, representing passing loops as pool units 704, representing train types of trains that may traverse each batch process unit or pool unit as operation modes 706, and representing connections between sections, and from sections to passing loops, as relationships between operation modes 708. The process systems model of the rail system does not need to strictly conform to all aspects of process systems modelling methodology. Rather, the process systems modelling methodology provides a framework to assist with modeling the elements of a rail system as if they were elements in a process system. Differences between train networks and process systems, however, still need to be reflected in the model of the rail system. These differences are reflected by adding additional constraints to the model, or relaxing certain in the model. Such model differences may not conform to the conventions of a process system modeling methodology.

Once a rail system has been modeled in accordance with a process system model, the model may be used to help determine an optimal configuration of various aspects of the rail system. For example, the model may be used to help determine a train schedule or identify infrastructure changes to the rail system to improve train throughput. The use of the model depends, in part, upon the goal/objective to be achieved. There may be many types of objectives that are of interest with respect to a rail system.

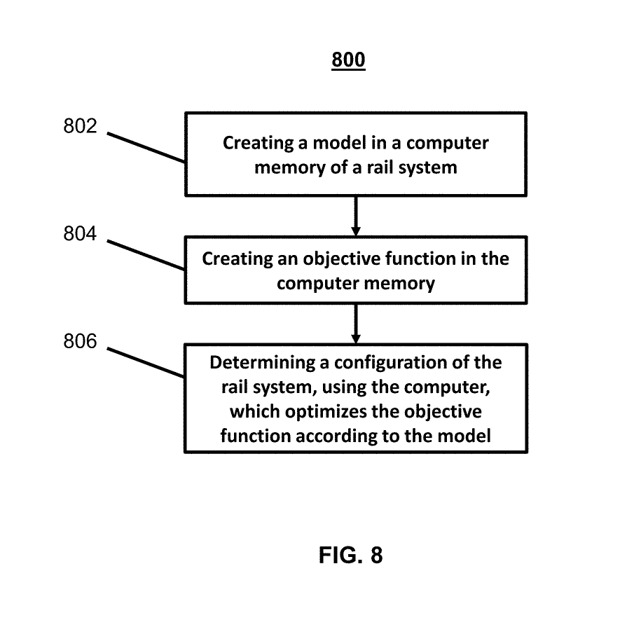

FIG. 8 shows a flow chart of a method 800 for determining, using a computer, a configuration of a rail system for optimizing an aspect of that rail system. The method 800 comprises creating a process systems model 802 of the rail system in a computer memory; creating an objective function 804 in the computer memory, the objective function corresponding to the aspect of the rail system to be optimized; and determining a configuration of the rail system 806, using the computer, which optimizes the objective function in accordance with constraints in the model. The system for this method may comprise a computer, and a memory storing a program configured, using the computer, create the process systems model in the memory, create the objective function in the memory, and optimize the objective function. The memory may store an optimization solver program to assist with optimizing the objective function.

In an embodiment, the method comprises determining a train schedule which optimizes an aspect of the rail system. For example, the train schedule may be to maximize the percentage of time sections of the rail system are occupied by trains. In another embodiment, the train schedule may be to minimize the number of times passing loops are used by trains. In an embodiment, the model comprises or is provided with a list of trains, each train's departure location and destination in the rail system, and the time at which each train is to reach its destination. In another embodiment, the model comprises or is provided with the minimum and/or maximum total number of trains of a certain type that must traverse the system within a particular time horizon. Trains may be weighted differently in the model such that the arrival and/or departure of certain trains' results in a greater number of points being awarded than the arrival and/or departure of other trains. The points may correspond to financial incentives such as costs or revenues.

The first step of the method 800 is to create a process systems model 802 of the rail system in a memory of a computer. The units of the model represent real-world elements in the rail system such as track sections and passing loops. The model of the rail system is created base on methodology/framework used to model a process system, such as the UOPSS framework. It is essential for the model to be created in a computer memory since any optimization operation performed with the model (such as determining a train schedule) requires the use of a computer. The model of a rail system is complex. As further described below, only a computer is capable of determining a solution to the optimization problems resulting from the complex model of the rail system.

The second step of the method 800 is to create an objective function 804 in the memory of the computer. The objective function is a mathematical expression or function representing a particular goal to be achieved by the rail system. The objective function comprises decision variables expressed as a linear relationship. The decision variables represent real-world relationships and/or factors which need to be considered and/or configured. The decision variables are used to assess whether a particular configuration of the rail system is better or worse than another. Optimization comprises identifying the values of the decisions variables which maximizes or minimizing (depending on the goal) the objective function but which also adhere to the constraints imposed on the decisions variables as a result of the equations in the model. This is referred to herein as optimizing the objective function for, or in accordance with the constraints in, the model.

The following are examples of the types of objective functions for optimizing an aspect of the rail system: determining a feasible train schedule for the rail system for a particular time horizon (e.g. seven days); determining a train schedule which minimizes the usage of passing loops by all trains; determining a train schedule which maximizes the utilization of all sections in the rail system; determining a train schedule which minimizes the amount of time it takes for trains of a particular type to travel to its destination.

Decision variables typically represent the degrees of freedom in a system. Decision variables have coefficients which indicate how much a decision variable contributes to the value of the objective function. What decision variables are included in the objective function depends on the objective, namely, the value to be optimized.

If the goal is to minimize use of passing loops by trains, the objective function may comprise decision variables representing the number of pool units used by the trains. The coefficients for those decision variables may reflect a real-world penalty value (e.g. monetary cost) associated with the use of a pool unit. Multiple decision variables (instead of a single variable) may be used in the objective function to more precisely represent real-world considerations when trains use passing loops. For example, a higher penalty value may need to be reflected in the objective function when a train with a higher priority uses a passing loop. In other words, the objective function may comprise a decision variable corresponding to a passing loop penalty for each train type in a rail system. In another example, a lower penalty value may need to be reflected in the objective function when passing loops which are closer to a port (such as a station) are used. This is because passing loop usage closer to a port (or at a crew changeover train station) may be more acceptable (and therefore attributed a lower penalty value) than usage of passing loops (and associated delays) at other locations. The objective function may comprise decision variables for different passing loop penalties based on spatial prioritization for the usage of passing loops.

The following is an example objective function representing the minimization of the time all train types m spend in all passing loops pl, in all directions d over the entire decision-making time horizon NT which is represented by the summation of all inventory amounts Inv_{pl,t} (weighted by their respective penalty values wₚₗ):

$$min {\sum }_{t = 1}^{NT} {\sum }_{pl = 1}^{NPL} {\sum }_{m = 1}^{NM} {\sum }_{d = 1}^{ND} {w}_{pl , m , d , t} \cdot {Inv}_{pl , m , d , t}$$

The third step of the method 800 is to determine a configuration of the rail system 806, using a computer, which optimizes the objective function according to the model. Optimizing the objective function according to the model means that the collection of decision variables which optimizes the objective function also satisfies all of the constraints of the equations underlying the model.

If the goal is to determine a train schedule, the third step of the method 800 is to determine, using a computer, a train schedule 806 which optimizes the objective function according to the model. A train schedule may comprise the departure and arrival time of each train at one or more locations in a rail system. Alternatively, a train schedule may comprise periods of time when each train is at a particular location in the rails system. A location may be a section of the rail system, a passing loop, or a station. The locations may be all of the sections of the rail system or all of the stations.

In an embodiment, the computer uses an optimization solver program to determine the values of the decision variables which optimize the objective function while adhering to the constraints in the model. Optimization solver programs are commercially available. IBM ILOG CPLEX™ optimizer is an example of a commercially available optimization solver program. The model and objective function may be provided to an optimization solver program through an application programming interface. The optimization solver program may return the values of the decisions variables as objects. Generally, the optimization solver program identifies the values of the decisions variables which optimize the objective function using various search strategies. Using the search strategies, the optimization solver program effectively considers many of the possible configurations of the rail system over a specified period of time. The search strategies are constrained by the search space based defined by the model.

Optimization consists of either maximizing or minimizing the value of the objective function, depending on the corresponding goal to be achieved with the rail system. An objective function may be optimized within a specified optimality tolerance to reduce the amount of time it takes to arrive at the solution. Determining a solution using an optimality tolerance may not result in the most optimal solution. That solution may still be sufficiently optimal, however, for the intended purpose with the benefit being that it took less time (and sometimes significantly less time) to compute the solution. By relaxing the model of the rail system, an upper bound maximum or lower bound minimum of the objective function can be determined for the purpose of assessing the optimality of a solution. For clarity, relaxation does not identify the values of the decisions variables of the objective function which results in optimization, it simply helps provide an upper or lower bound.

A computer is an essential element of the method and system of the present disclosure. A computer is required to optimize an objective function in accordance with a process systems model of a rail system. Because of the complexity of a rail system, a human operator would be unable to solve such an optimization problem manually (i.e. without a computer), and certainty not within a period of time that would allow the solution to be useful. As shown below in relation to Table 1, determining a train schedule for just a 2-day time horizon can result in 382,474 decisions variables and a model resulting in 470,994 equations. A solution to that large number of equations and decisions variables would be impossible to compute unless a computer is used. Even if it were possible to determine a solution manually, it would take an exceeding long time to do so. A rail network is a dynamic environment. Train schedules, for example, need to be generated within a reasonable amount of time from the point at which a model of the actual environment is created. What is a reasonable amount of time depends, in part, on the purpose of the train schedule. For online applications, a train schedule would need to be generated within a few minutes. For offline planning purposes, a train schedule would preferably be generated within 30 minutes. It may indeed be acceptable for a train schedule to be generated within a period of hours. It is unlikely that a train schedule would be of much use for operational purposes if it took multiple days to generate. If it takes too long to create a train schedule, the actual rail network will have sufficiently changed such that the model is out of date. A train schedule resulting from an out of date model cannot be used for the purpose of scheduling trains. Furthermore, it would be infeasible to suspend all activity on the rail network while a solution is being determined without a computer. Suspending all trains on a rail network for even a short period could result in significant economic losses.

Once a train schedule has been determined, the trains in the rail system may be operated in accordance with the train schedule. Depending on the system, the trains may be automated so that they automatically operate in accordance with the train schedule. The trains may be dispatched from their starting locations according to the train schedule. The signals which are used to control the flow of trains through the rail system may be operated in accordance with the train schedule.

The speed of trains may also be regulated for each of the sections so that the train adheres to the train schedule. Indeed, slower, constant, train speeds may result in a more optimized rail system if the slower speeds results in less or no conflicts. A train requires significant energy and time to change velocity. The heavier the train, the more time and energy required. Accordingly, changes in train velocity are preferably avoided. If a particular train schedule guarantees no conflicts and therefore no scheduled changes in train velocity, it may be preferable to adhere strictly to that schedule notwithstanding that certain trains may be able to travel faster in certain sections.

The following describes different purposes for which the system and method of the present disclosure may be used. The purpose determines the objective function, and the decision variables of the objective function identify what aspects of the rail system may be configured to achieve the purpose.

In an embodiment, the system and method may be used to obtain a feasible train schedule given a particular train launch timetable.

In an embodiment, the system and method may be used to identify a train schedule which minimizes the usage of passing loops for all train types given a pre-specified train launch schedule where train dispatch times are specified at the battery limits to the problem. In other words, the model comprises or is provided with the departure location of each train, and the window of time within which each train is required to depart. The solution to this objective may be a sufficient but indirect proxy for a schedule that minimizes the runtime of trains through a rail system.

In another embodiment, the system and method may be used determine a train schedule that maximizes the number of trains running through the system. This can help determine the rail system's maximum capacity and/or identify bottleneck sections. The objective function of this objective may be expressed as the maximization of all of the train flows leaving the system in both directions, for all train types. The model may comprise constrains to inhibit the optimizer from attempting solutions which only send the shortest trains through the rail system.

In another embodiment, the system and method may be used to determine a revised train schedule for recovering from an unforeseen event, such as a locomotive breakdown. In this case, the model of the rail system is adjusted to reflect the rail system after the event, and a revised train schedule is determined using the adjusted model so as to re-established traffic as quickly as possible. The revised train schedule may be optimized to reestablish, as quickly as possible, operation of the rail system according to the original train schedule prior to the event. This is a challenging task for conventional train scheduling simulation software since the rules and heuristics used by such software are based on launching trains from stations at the extremes of the rail line, as opposed to stations within the rail system. In an embodiment, the process systems model of the rail system is populated to reflect start of schedule conditions such as train locations. This may be accomplished by setting the values of setup binary variables to the value of “1” at start-of-schedule in the sections in which trains are staged. This is also referred to as setting a baseline in a process systems model.

It can be difficult for rail operators to determine the maximum capacity of their rail systems. Operators may rely on historical train schedules and/or hypothetical estimates of maximum capacity. In an embodiment, the method and system may be used to determine the maximum useful rail system capacity, which may then be maximized for the existing track infrastructure.

The flexibility in the scheduling of trains in a rail system may be greater when the rail system comprises many long passing loops and a large yard capacity at every station. Such flexibility, however, is at the potential expense of inflated capital requirements to construct the passing loops and yard capacity. Scheduling efforts are also typically simplified in dedicated (single purpose, same train priority, homogenous train and passing loop design) rail lines. In systems with limited passing loop infrastructure and mixed (e.g. freight/passenger) utilization, however, more sophisticated models, algorithms, and computation may be required.

Limited-flexibility rail systems are often the results of multiple expansions or upgrades that are implemented over a period of time (years or decades). Such rail systems make it challenging to manually schedule trains. Such rail systems also make it difficult or impossible for discrete event simulation tools, rule-based scheduling tools, and heuristic-based scheduling tools to determine a conflict-fee train schedule for a particular time horizon. This is because such tools are unable to account for all of the complexities of the rail system when attempting to determine a rain schedule. Attempted use of such tools for limited-flexibility rail systems may result in lower utilization of rail system capacity than what is actually available. Attempted use of such tools for limited-flexibility rail systems may also result in very slow recovery from unforeseen disruptions to the operation of the rail system, such as locomotive breakdowns. Indeed, some conventional tools are unable to schedule trains in a rail system that already contains trains at certain locations in the system because of the added complexity. Given the capital intensity typically required to expand on existing rail infrastructure, there is also significant interest in methods and systems which can optimize the use of existing rail systems, and/or identify the best track expansion locations to improve efficiency.

In an embodiment, the method and system may be used to assess the optimal phasing of expansion of rail infrastructure by either extending existing passing loops, or adding new ones to the system. This can be achieved by adding a binary variable to the model that corresponds to the usage of each passing loop expansion option, and penalizing any use with its corresponding capital expenditure amount in the objective function. Therefore, given the values assigned to each completed train trip, the optimization will only use the extra expansion if the increased capacity benefit outweighs its required capital expenditure.

In another embodiment, the system and method are integrated with a train control system of a rail system. The train control system may automatically provide the system and method with real-time or near real-time information regarding elements and/or events in the rail system. For example, information about an event may be received within less than 5 minutes after the time at which the event occurred. The information may be provided continuously or periodically. The information may include the location, speed, and direction of trains in the rail system. The information may also include train conflicts, train malfunctions, section availability, and scheduled track maintenance. Using this information, the system and method may be provide a real-time or near real-time train schedules.

In another embodiment, the system and/or method operates in real-time, receiving batch or continuous updates concerning the state of the rail system for the system and method to provide rapid, short-term optimization of the rail system, including when there is an upset to, or an unexpected event in, the rail system.

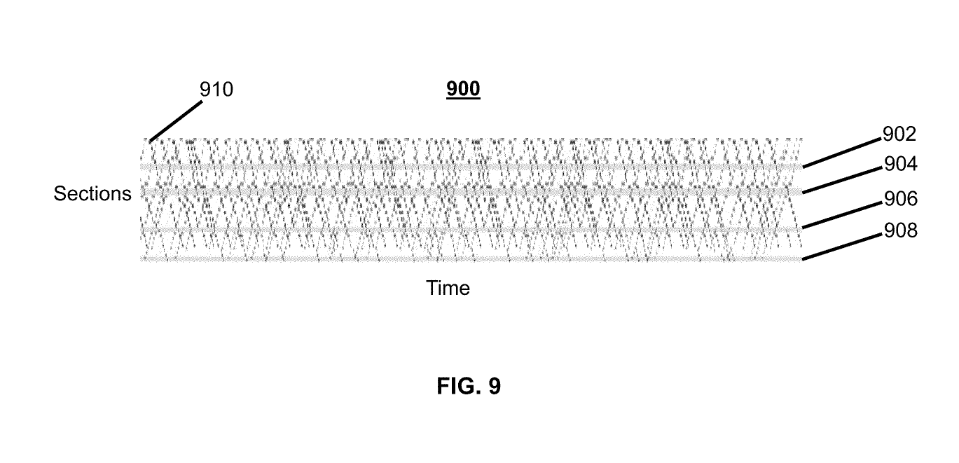

FIG. 9 shows a Gantt chart 900 of a 1-week train schedule for a large-scale, real-world, rail system determined according to an embodiment of the system and method of the present disclosure. The rail system comprised 21 sections, 16 passing loops, and 5 different train types. The rail system was a mixed-use rail corridor of 370 kilometers. Conventional train scheduling software was unable to find a feasible train schedule for this rail system greater than a 2-day time horizon.

The vertical axis of the chart 900 represents each rail section in the rail system. The horizontal axis of the chart 900 represents discrete time periods in 10 minute increments (although another value could have been selected such as 1 minute increments or 1 hour increments). Rows 902, 904, 906, and 908 represent double rail sections which may simultaneously accommodate trains traveling in both directions. Each block 910 represents a particular train at a particular section for a particular time period. The colour of the block represents the train type.

In the model of the rail system, a time step of 10 minutes was used. This was because of the short travel times between stations. In the model, all train runtimes were also rounded up to the nearest 10 minute increment to achieve a more conservative solution.

An objective function was created to minimize the usage of passing loops for all train types given a pre-specified train launch schedule.

The method and system was implemented using the C++ programming language. Commercial optimization software IBM ILOG CPLEX™ was used to optimize the objective function. The software ran on a laptop computer with an 8-core Intel Core 2.40 GHz processor and 8 GB of RAM. The optimality tolerance for all cases was set to 5%.

In a first case, the method and system were used to determine a 2-day train schedule. For this first case, the decision variables of the model comprised both continuous variables and integer variables. This resulted in a large scale mixed-integer linear program (MILP). A continuous variable can be any floating point number that is positive or negative. An integer variable can only be a positive, zero, or negative whole number. Details concerning the model statistics for this case are set out in Table 1, below. The details comprise the number of decision variables in the model, including the number of integer decision variables and continuous decision variables both for the original problem statement as well as the number of presolved variables after IBM ILOG CPLEX™ presolving operations. The details also comprise the number of equations and the number of non-zero elements.

In the first case, the time required to determine the first integer-feasible solution was approximately one minute. The time required to determine an optimal feasible solution (i.e. within 5% of the most optimal solution) was approximately 20 minutes. Details concerning the solution performance statistics for this case are set out in Table 2, below.

In a second case, the decision variables of the model were made to comprise only integer decision variables. More specifically, all dependent continuous decisions variables were explicitly declared as integer such that the model became a pure integer programming (IP) model. This resulted in more binary variables in the model. Table 1 provides the model statistics for this case. Significant improvements were observed in the time required to find an optimal solution with this model as compared to the model in the first case. In fact, the most optimal solution (i.e. within 0.0% of the most optimal solution, also known as a provably optimal solution) was determined within 58 seconds—an 18-fold improvement in solve time as compared to solving the MILP model of the first case. Table 2 provides the solution performance statistics for this second case. The improved results are believed to be due, in part, to the cascading solution characteristics inherent to rail scheduling systems.

In a third case, the IP model of the rail system was used to determine a 7-day train schedule. Conventional train scheduling software is unable to determine a feasible train schedule, let alone an optimal train schedule, for a 7-day period. The third case resulted in a model with over 1.3 million binary variables, 1.6 million equations and over 4 million nonzero elements. This solution to the objective function was determined within less than 20 min. Table 1 provides the model statistics for this third case, and Table 2 provides the solution statistics for this third case.

TABLE 1
Model Statistics (Pre-solved values in parentheses)

| Case | #Variables | #Equations | #Non-Zeros |
|---|---|---|---|
| 2 Days | 382,474 | 470,994 | 1,265,737 |
| (MILP) | (11,262 integer | (63,843) | (214,660) |
| | variables, | | |
| | 26,969 continuous | | |
| | variables) | | |
| 2 Days | 382,474 | 470,994 | 1,265,737 |
| (IP) | (38,328 integer | (63,810) | (215,328) |
| | variables) | | |
| 7 Days | 1,338,634 | 1,627,314 | 4,412,857 |
| (IP) | (235,165 binary | (380,726) | (1,316,240) |
| | variables) | | |

TABLE 2
Solution Performance

| | 1^{st} Feasible | Optimal | Optimality |
|---|---|---|---|
| | Solution | Solution | Gap of |
| Case | (CPU second) | (CPU seconds) | Solution (%) |
| 2 Days | 74* | 1,080 | 5.0 |
| (MILP) | | (Node 20,072) | |
| 2 Days | 48* | 58* | 0.0 |
| (IP) | | | |
| 7 Days | 1,132* | 1,132* | 0.0 |
| (IP) | | | |

*Solution obtained within CPLEX heuristics, prior to branch-and-bound

1. A method for determining a train schedule for a rail system using a computer, comprising:
creating in a memory of the computer a process systems model representing the rail system, the process systems model comprising variables;
creating in the memory an objective function comprising decision variables corresponding to one or more of the variables in the process systems model; and
determining, using the computer, the train schedule by identifying the values of the decision variables which optimize the objective function for the process systems model.

2. The method of claim 1, wherein the process systems model is a Unit-Operation-Port State Superstructure model.

3. The method of claim 1, wherein creating the process systems model comprises:
representing a section of the rail system as a batch process unit; and
representing train characteristics of trains, which may traverse the section, as operation modes associated with the batch process unit.

4. The method of claim 3, wherein creating the process systems model comprises:
representing a passing loop of the rail system as an pool unit; and
representing train characteristics of trains, which may traverse the passing loop, as operation modes associated with the pool unit.

5. (canceled)

6. A method for determining, using a computer, a configuration which optimizes an aspect of the rail system, comprising:
creating in a memory of the computer a process systems model representing the rail system, the process systems model comprising variables;
creating in the memory an objective function corresponding to the aspect of the rail system for optimization, the objective function comprising decision variables corresponding to one or more of the variables in the process systems model; and
determining the configuration based on identifying, using the computer, values of the decision variables which optimize the objective function for the process systems model.

7. The method of claim 6, wherein the process systems model is based on the Unit-Operation-Port State Superstructure methodology.

8. The method of claim 6, wherein creating the process systems model comprises:
representing a section of the rail system as a batch process unit; and
representing train characteristics of trains, which may traverse the section, as operation modes associated with the batch process unit.

9. The method of claim 8 wherein creating the model comprises:
representing a passing loop of the rail system as a pool unit; and
representing train characteristics of trains, which may traverse the passing loop, as operation modes associated with the pool unit.

10. The method of claim 8, wherein creating the model comprises representing track characteristics in the operation modes.

11. The method of claims 8, wherein the train characteristics comprises one or more of train size, train speed, train direction, and train priority.

12. The method of claim 10, wherein track characteristics comprises one or more of section availability, and the number of parallel rails.

13. The method of claim 8, wherein creating the process systems model comprises representing a connection between two sections as a relationship between the operation modes of the batch process unit for each of the two sections.

14. The method of claim 9, wherein creating the process systems model further comprises representing a connection between the section and the passing loop as a relationship between the operation modes of the batch process unit and the pool unit.

15. The method of claim 6, wherein the aspect of the rail system for optimization is a train schedule for the rail system.

16. (canceled)

17. The method of claim 6, wherein the variables are defined in the memory as a combination of continuous and integer variables.

18. (canceled)

19. (canceled)

20. (canceled)

21. (canceled)

22. (canceled)

23. The method of claim 8, wherein creating the process systems model comprises adding a block section variable to the model in response to the rail system having a series of sections between passing loops of different lengths, the block section variable to permit or prevent use of all of the batch process units associated with the series of sections.

24. The method of claim 6, wherein the aspect for optimization is the track configuration of a portion of the rail system, the configuration selected from a plurality of potential track configurations.

25. (canceled)

26. The method of claim 14, further comprising operating trains in the rail system according to the train schedule.

27. (canceled)

28. (canceled)

29. A system for determining, using a computer, a configuration which optimizes an aspect of the rail system, comprising:
a computer; and
a memory storing a program configured to, using the computer,
create in a memory of the computer a process systems model representing the rail system, the process systems model comprising variables;
create in the memory an objective function corresponding to the aspect of the rail system for optimization, the objective function comprising decision variables corresponding to one or more of the variables in the process systems model; and
determine the configuration based on identifying, using the computer, values of the decision variables which optimize the objective function for the process systems model.

30. The system of claim 29, wherein the memory stores an optimization solver program.
